(19) United States
(12) Patent Application Publication
(10) Pub. No.: US 2009/0327899 A1
(43) Pub. Date: Dec. 31, 2009

(54) Automated Creation of Virtual Worlds for Multimedia Presentations and Gatherings

(76) Inventors: Steven Bress, Germantown, MD (US); James Edward Dunstan, Springfield, VA (US)

Correspondence Address: Steven Bress, 17917 Wheatridge Drive, Germantown, MD, 20874, US

(21) Appl. No.: 12/491,723

(22) Filed: Jun. 25, 2009

Related U.S. Application Data
(60) Provisional application No. 61/075,340, filed on Jun. 25, 2008.

(51) Int. Cl. G06F 3/048; G06F 3/00

(52) U.S. Cl. 715/731; 715/757

(57) ABSTRACT

Systems and Methods for automated creation of Virtual Worlds for Presentations and gatherings. By leveraging the ease of use of commercial presentation tools, such as PowerPoint®, inexperienced users can create fully immersive virtual worlds. Within the virtual world, the presentation information is formatted and displayed in an appropriate way to one or more simultaneous users, which may interact through their avatars in the virtual world. Provisions are included for the presenter to control the pace and display of the presentation.

### BACKGROUND OF THE INVENTION

A. Field of the Invention

The present invention relates to using Virtual Worlds for presentations and gatherings, more specifically, to systems and methods for automatically creating virtual worlds with a minimum amount of user intervention for such purposes.

B. Description of Related Art

Multi-Player Virtual World Games (MVWG) are well known in the entertainment art and include such online computer games as Everquest, Dark Age of Camelot, Second Life, and World of Warcraft. In general, a player uses a home computer as an interface to these games. PowerPoint® by Microsoft Corporation is a well known presentation tool that is extensively used for creating corporate and business presentations. Many corporations are experimenting with creating virtual worlds for in-house uses and marketing. IBM and some others have hosted Job Fairs in Second Life.

Second Life is typically used for these experiments in corporate virtual worlds, as one of its features is to allow users to create their own areas. This allows a user with substantial technical skills to create a customized area within a larger virtual world. The user does not have to get involved with the technical details of how the world works, he may stay focused on using the supplied tools to create his world.

There are a number of problems faced by a user who intends to use a general purpose game or virtual world such as Second Life as a presentation and gathering tool. The first of which is that it requires more than a casual amount of time and effort to create a rudimentary virtual world, and most business uses require a high degree of polish. That can make the budget for creating a virtual world, even with the tools provided by second life, unreasonably high and the time frame for creating, testing, and deploying such a world unreasonably long. Dedicated technical support within an organization is required for the development of presentations in preexisting virtual worlds.

One of the reasons that PowerPoint® is so popular for presentations is that almost anyone who can use a word processor can use it to create a reasonable looking presentation. It is quick to learn, and with standard templates, even novices can create professional looking presentations with only a short learning curve. Indeed, most school children today are taught how to use PowerPoint® for presentations.

There is a need in the art for the sophistication of a presentation done in a virtual world such as Second Life that can be created with the same skill level a PowerPoint® Presentation can be created.

### SUMMARY OF THE INVENTION

The present invention is directed toward a software system that imports a presentation, such as one created in the PowerPoint® file format, and displays said presentation in a virtual world. In the present invention's most basic form, a presentation of “x” slides is imported to a premade virtual world with “x” display areas. Once the virtual world presentation is complete, the software system prepares the presentation in a format that can be hosted on a local computer or server. The key observation is that the present invention allows a relatively untrained PowerPoint® type presentation creator to create a much more sophisticated Virtual World presentation with a minimum of effort or training.

An additional aspect of the current invention is directed toward some customization of the virtual world. Thus, the presentation creator may have a choice of virtual worlds, such as corporate boardroom, museum, castle or beach to choose from. These “world templates” may be used “as-is” or they may have the ability to be modified. An unskilled user may be given the opportunity to drop key information, such as a corporate logo or other graphics or information in various areas, such as a banner over a doorway.

An additional aspect of the current invention is directed toward ensuring a virtual world presentation attendee easily views the presentation. Thus the present invention encourages the attendee's avatar to move and face in such a manner as to view a particular slide. This may be done by making an avatar easier to move in a certain direction.

Technical limitations of the hosting system may limit the number of attendees. Additionally, there may be reasons to restrict some attendees from full participation within the virtual world. Therefore an additional aspect of the current invention is directed toward a shared or “ride along” avatar. This shared avatar would follow a path set by the presentation creator. Additionally this shared avatar would not be able to talk to the other avatars around him.

Methods to control social conversation in a virtual world are well known in the art, such as friends' lists and ignore lists. These lists are typically stored on a users' computer and thus could be used in various virtual worlds. In order to ensure that attendees do not miss any remarks from a presenter, the current invention is additionally directed toward temporarily over-riding existing social lists. This typically would be the inclusion of the presenters into the attendees friends lists. Means to associate live speech to an avatar are well known in the art. Just as in a real world presentation, in a virtual world presentation it may be advantageous that the presenters' speech is louder than the attendees. Additionally, during a Question and Answer session, an individual attendee may need to be louder than others. To address these concerns the present invention is additionally directed toward controlling audio levels. This is accomplished by first examining and then leveling individual audio streams. Additionally, presenters are given tools to control audio levels (up and down) for individuals and classes such as presenters and attendees.

An additional aspect of the present invention is directed toward playback of audio. All or part of the presentation may be recorded for review at a later date. In particular attendees are given tools to instant playback a short section of audio.

### BRIEF DESCRIPTION OF THE DRAWINGS

The accompanying drawings, which are incorporated in and constitute a part of this specification, illustrate the invention and, together with the description, explain the invention. In the drawings,

FIG. 1 shows the path that an Avatar might take if controlled by a user as opposed to “attraction gravity”.

FIG. 2 shows “leveling” of audio streams.

### DETAILED DESCRIPTION

To help simplify the following discussion, PowerPoint® will be used as an example of a presentation program and Second Life will be used as an example of a user modifiable virtual world system. These are just examples and the present invention is intended to cover the export and creation of virtual presentation worlds from a number of non-3D applications.

The present invention bridges the gap between a presentation package, such as PowerPoint®, and a virtual world system, such as Second Life. The present invention has a number of features that allow anyone with PowerPoint® experience to quickly create a fully immersive presentation in a virtual world. By quickly, it is meant that the world may be created in just a few minutes by the present invention. To create a similar world in Second Life can take from weeks to months. In its simplest embodiment, in order to create a virtual world, the user would only have to take the following steps:
1. Create a PowerPoint® presentation.
2. Click the “Build a Virtual World” menu item that the present invention adds to the PowerPoint® menu structure.
3. Select the style of virtual world for the presentation. (i.e. Beach scene, museum scene, castle, corporate boardroom, etc.) The present invention determines the size of the presentation world based on the number of slides and automatically generates the world based on this minimal input.
4. Run the resulting application on a local computer or upload the results to a server to allow others to join the presentation.

Those few steps are all that it takes to create a basic virtual world. There are a number of other options that may be selected to enhance the experience, but this is all it takes to get started. No knowledge of 3D programming, scripting languages, art, or 3D texture mapping techniques is required.

In addition to moving the presentation from a 2D display format to a 3D virtual world, the present invention has features to insure that the presentation experience will be similar or even identical for all users within the world, yet allowing the viewers to be anywhere in the real world. As an example, if a slide from a presentation were displayed on a wall in a virtual museum, the viewer could walk past the slide. One of the features of the present invention is that of “attraction gravity”. In this case, the attraction is the slide on the wall. As a user moves his avatar towards the slide, the avatar will be gently pulled and positioned for the proper viewing angle on the slide. If allowed by the presenter, the user could override the pull and move on, but the path of least resistance would be to view the slide at the proper angle and orientation.

Similarly, in a presenter led presentation, when it is time to move from one slide to the next, the group would be gently pulled along to the next slide by the presenter. When near the next slide, the attraction gravity would take over and position each member of the group appropriately for optimal viewing.

In another embodiment, the creator can record an audio file for each slide, and with a single click in the present invention's application, a sound “kiosk” is created in the virtual presentation world. With this sound kiosk, the sound recording is triggered when a viewer approaches the slide or triggered by user interaction, among other methods. Similarly, if a presentation is done “live” the current invention features a “record” option such that the presentation can be saved and experienced by future users listening to the “live” presentation.

The following detailed description of the invention refers to the accompanying drawings. The same reference numbers in different drawings identify the same or similar elements. Also, the following detailed description does not limit the invention.

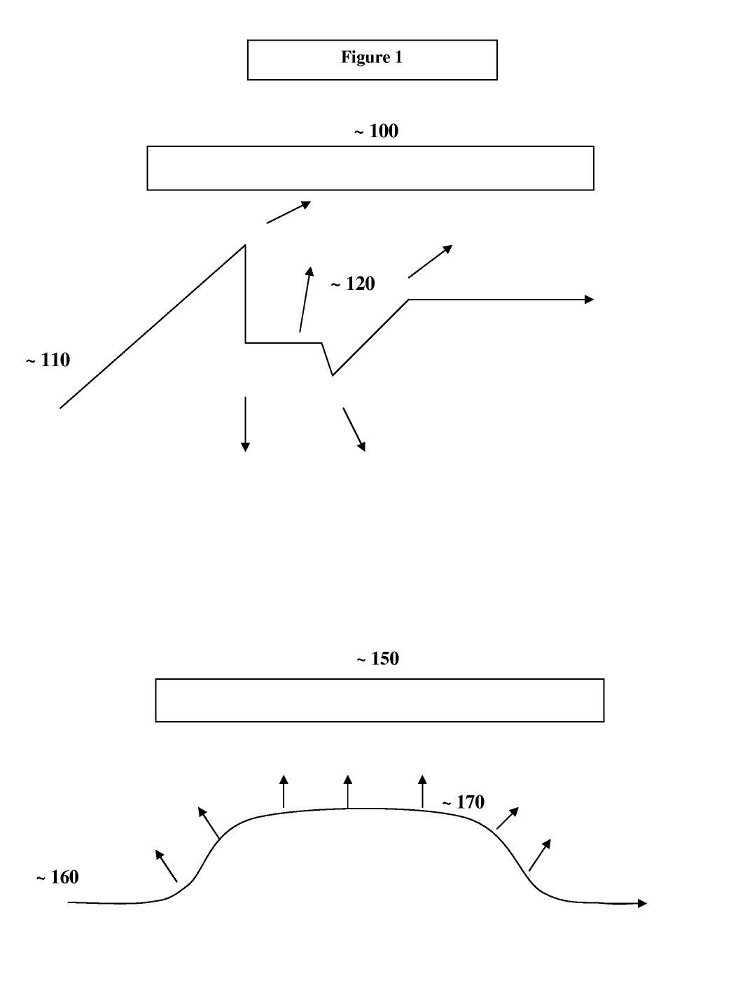

FIG. 1 graphically illustrates how “attraction gravity” can modify the path that an avatar takes when moving into view of a slide 100. Path 110 shows what a path may look like if the avatar's motion and facing is controlled entirely by the user. With a few course corrections, this avatar is facing the screen 120. The course is not smooth, and the final facing is not guaranteed to be aligned properly with the slide. Path 160, on the other hand shows the smoothness that attraction gravity can bring to the path. In this case, the current invention can adjust the facing 170 and path 160 that the avatar takes as it approaches and leaves the vicinity of a slide 150. This level of control is difficult for a user to match throughout a presentation.

The process of exporting a presentation from a program such as PowerPoint® is straightforward to the user. It requires a minimum amount of user intervention and no training whatsoever in the field of 3D computer graphics or virtual worlds. The newly created virtual world can be viewed immediately upon its creation. It can also be sent to anyone else for viewing on their computer in a similar manner to how PowerPoint® makes a standalone viewer for its presentations. For some users, this is all that they will want to do. Instead of a flat presentation, they can send around a more immersive type of presentation for any one other person to watch.

Since the present invention is actually creating a multi-user capable virtual world, uploading the presentation to an appropriate server allows other users to simultaneously view the presentation from disparate locations. In its simplest embodiment, the present invention creates 3D webinars.

One of the methods used by the present invention to create a 3D world is to make use of templates. In its simplest form, a template may have the basic design for a 3D presentation world with designated spaces to place slides from PowerPoint®. In one embodiment, the templates are designed for a specific number of slides. In another embodiment, templates are designed for a variable number of slides, and placement is dynamically changed based on the number of slides in the presentation.

The present invention addresses the need and desire to share presentations with others, while allowing interactivity with the presentation and other viewers of the presentation. While presentation software is not new, the ability to easily view a presentation in a virtual world is new. At its simplest, the invention can be used for a presentation just like PowerPoint®. A presenter takes control of the presentation and can move the display from slide to slide. Unlike PowerPoint®, the present invention allows for the presenter and the viewers to be represented by their avatars in the virtual world. One of the immediate benefits of this is that it is less important that all of the viewers be physically present in the same room.

While there are methods to view a PowerPoint® presentation remotely, it does not have the same impact as the shared experience of being in the group. With the virtual world, all of the viewers may share the experience, interacting with each other and the presenter in real-time, regardless of their physical location. The present invention incorporates a number of features that enhance the viewing experience for the remote viewers, and allow the presenter to have some control over the experience.

In a Virtual World game, such as World of Warcraft, there are not many restrictions as to what the player can do within the confines of the game. While this freedom is ideal for gaming, it does not always translate well into a presentation or corporate gathering scenario. In a presentation, someone tends to be in charge and leads the discussion. Similarly, for a corporate gathering, there tends to be either a speaker or a master of ceremonies. In any real-world social gathering, there are times when it is appropriate to attend to those in charge and times when it is appropriate to mingle freely.

The present invention has a number of features that can help enforce or reinforce real world social etiquette to the viewers in the virtual world. For instance, the presenter can force the group to stay together during the presentation, rather than having the freedom to look ahead or wander away. For a presentation using the voice communication features of the present invention, the presenter may choose to mute or at least reduce the relative volumes of all of the viewers so that no one viewer can disrupt the proceedings.

Within the virtual world, there are a number of ways in which the presenter may show himself to the viewers. The simplest way is for the presenter to be represented by an avatar like the other viewers. For more impact, the presenter's avatar may include a real-time video feed of the actual presenter. In one embodiment, this would replace the avatar's head with a video feed showing the presenters face. This has an obvious benefit of allowing the viewers to see even the small facial expressions of the presenter. One aspect of the present invention is that each viewer would be shown an appropriate angle for the video mapped to the presenter's avatar. So even if the viewer were off to one side, the presenter's avatar's video would still face him.

While on the topic of facial expressions, another aspect of the present invention is to allow the use of input devices to create real-time modifications to the avatar's facial expressions and other behaviors. For instance, a standard tilt sensor on a hat can provide the appropriate head tilt for an avatar. While this would seem to be a simple motion, watching the head tilt in an audience is a quick way to gauge the overall attention level of the audience.

Other input devices such as brain wave sensors and body position detecting cameras may be used to automatically input behavior cues to the avatars. For more precise and specific input, the user has the option to use joystick, mouse, or keyboard control to command the avatar to show a specific position or emotion.

There may be times where the number of people trying to view a presentation exceeds the capacity of the server hosting the presentation or the size of the virtual room in which the presentation is taking place. In this case, a special avatar is placed in the virtual world that represents the additional viewers. Viewers attached to this “ride along” avatar cannot directly control the avatar, but see the presentation from this avatar's point of view. The ride along avatar may also be used to separate spectators from participants in the presentation. For instance, a presentation may be technical geared toward engineers, but others in the company may be invited to view. By restricting their ability to interact, the viewers can be part of the group without distracting it.

In the preferred embodiment, the present invention includes tools that allow for the customization or creation of custom virtual worlds. For those with lesser graphics skills, the tools might be used to simply modify an existing template for a virtual world. An example might be to change the color scheme for a room to more closely match the company colors. A more skilled user would have the tools available to create an entire custom template for a virtual world. Such templates could then be shared online expanding the capabilities of the present invention.

When a presentation is packaged for display on another computer, all of the programs and files required to run the presentation are included. For the highest quality of the virtual world, this will usually be geared toward a specific hardware platform, such as a PC. In another embodiment, a cross platform version of the viewer may be created that will run the same presentation data on different machine types. This may take the form of a browser based viewer, or other standard cross platform applications such as Microsoft's SilverLight or Adobe's Flash.

In most multi-user virtual worlds, the individual user may choose who belongs on his list of friends. This friend's list serves an important function in a virtual world, as it can reduce the amount of chatter from people that are unknown to the user, and even prevent them from being seen. In a virtual world geared for presentations and corporate gatherings this manner of dealing with a friend's list is less than optimal. As a group gathers for a presentation, it would not work well if the group ignored the presenter by default, simply because he was previously unknown to the group. For a corporate gathering, the management would expect that the employees were ‘friends’, at least for the purposes of the gathering.

The present invention overcomes this limitation in the art by allowing for the creation of a ‘forced friends list’. When presenting to a group, for the duration of the presentation, the entire group may be declared as temporary friends or associates. The presenter would be forced to be everyone's friend, at least for the hours of the presentation. After the presentation is over, the temporary forced friends list can be saved as a special social circle or abandoned.

Typically this list would include the presenter and all of the attendees. This would allow for easy communication between the entire group. While each user may have his own friends (and ignore) list, the forced friends list would supercede the users lists, at least for the duration of the presentation.

Just like in the real world, viewers of the presentation have the ability to speak to other individuals in the group or to the entire group. The technical details of capturing and sending voice to a server are well known in the art, and will not be repeated here. The presentation adds to the art in its methods of processing audio from many unrelated streams into group or individual streams for the viewers.

The presenter may select which, if any, audio feeds are to be live during the presentation. For more of a real world feel, there is an option to not fully mute all of the feeds, but to dramatically reduce their perceived volume to the level of a background noise. With this feature, the presenter can be heard without concern of being drowned out by an unruly viewer. In another embodiment, the server detects that the presenter is speaking and automatically lowers all of the other audio streams so that the presenter is automatically heard over the other voices in the virtual room.

An additional feature of the present invention is that all of the audio streams are dynamically ‘leveled’ by the server. As an example, this may be done by a straightforward dynamic compression algorithm, or another algorithm measuring the energy in a stream. This feature compensates for drastic differences in the hardware producing the audio stream and the relative volumes of different people's speaking voices. Once each feed is leveled, they can be remixed as requested by individual viewers. On of the main benefits of this technique is that each user may specify a comfortable listening level for his environment and he will not have to make any adjustments for people talking too loudly or softly.

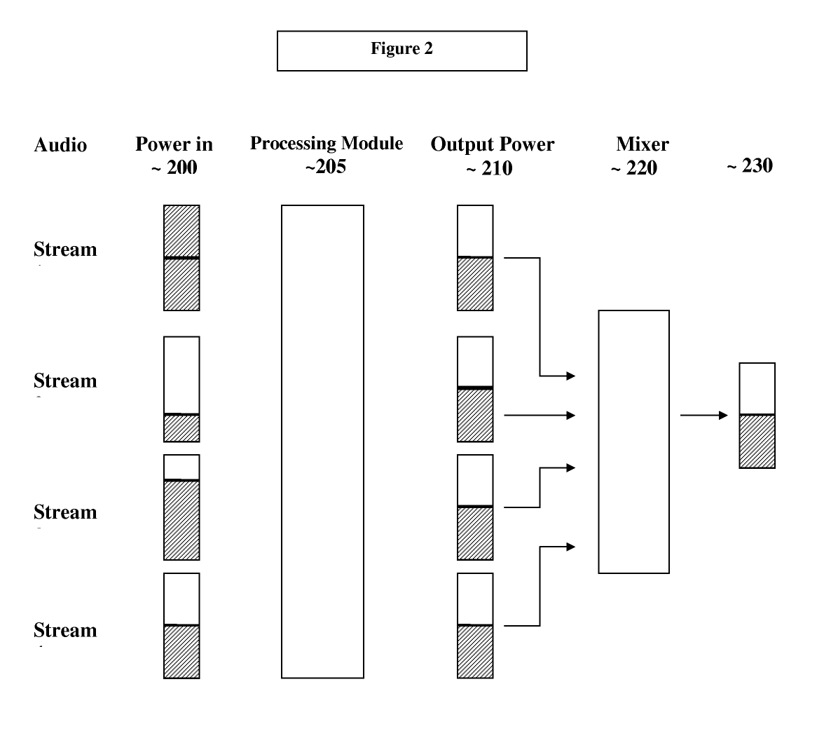

This is illustrated in FIG. 2. The power of each audio stream is measured 200. Each audio stream is measured to get the power in the stream, not just a peak volume. This power level is used by the processing module 205 to determine how to scale each of the audio streams in order to make the perceived volume of each stream equivalent. After the audio stream scaling, the output power 210 is the same for each stream, and is ready to be fed into the mixer module 220. The output of the mixer module 230 is then ready to be passed to all of the users.

One embodiment extends this concept by providing a mixer module 220 for each user rather than a single one for the group. With this feature, the user may have control over which audio streams are fed into the mixer. Another feature allows the user to set the relative volume of each stream individually. This allows the user to only hear conversations amongst friends, or even hear a ‘best friend’ clearly over the other voices.

In another embodiment, a feature provided by the present invention is the instant replay feature. With this feature, the viewer may back up to a previous point in the presentation and play it over. This feature is selectable to either replay the audio or both the audio and position within the virtual world. The audio only replay feature is important, in that it can be used to jump back a small number of seconds to hear what someone just said. There is an option to play back the audio as it was or mix the old audio with the new so as to be able to keep track of what is currently being said.

A business problem that is solved by the present invention is that Second Life and other similar games do not sell, lease, or otherwise make servers available to others. For corporate use, this can be a major problem in that it can be a major security risk to allow private conversations to be hosted on someone else's computers. In one embodiment, the invention will allow for virtual presentation worlds to be uploaded to secure servers behind firewalls with log-in and other security features to control access to only desired participants.

Even though the present invention is geared toward real-time shared presentations, there is no requirement for there to be more than one viewer. PowerPoint® presentations are already finding themselves on YouTube (www.youtube.com) as low resolution, non interactive videos. The present invention allows for an online repository of presentations that may be viewed interactively at a later time.

One aspect of the present invention is that the audio of the presenter is recorded along with the movements of the presenter through the virtual world during the presentation. When played back at a later time, this can give the viewer more of a feeling of having been there at the original presentation than just flipping through PowerPoint® slides. The viewer may choose to go along at the pace and path of the original presentation, or he may unlock from the original path and explore the presentation at his own pace.

In another embodiment, speech to text technology may be used to convert the presenter's talk from audio to text. This could be used as a simple transcript of the presentation or displayed in real time as a form of closed captioning.

In most cases, a PowerPoint® presentation may be directly translated into an appropriate format for the present invention. For presentations that are too complex, such as those that rely on third party applications for part of the display process, a real-time capture process may be used to import the presentation. Using this feature, the PowerPoint® show is played using PowerPoint®. The present invention monitors the graphics on the display and captures the display as it is shown. The operator may help identify the beginning of new slides using a predefined keystroke sequence. This method allows for the importation of a PowerPoint® presentation regardless of its complexity.

One method of creating a virtual world is to use the menu structure that the current invention can add to PowerPoint®. However, the present invention may allow for the direct importation of presentations saved in the PowerPoint®.PPT format. The present invention is not limited to PowerPoint® as a source of presentation materials. One skilled in the art would recognize that other presentation programs could be used for source material. In addition, an embodiment of the present invention may include a slide editor. This allows editing slides created in other applications as well as creating slides within the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Use of “him” or “her” are not gender specific an applicability to one gender or another of any feature or claim of this invention is not intended.

The above specification and examples provide a complete description of the structure and use of exemplary embodiments of the invention. Since many embodiments of the invention can be made without departing from the spirit and scope of the invention, the invention is defined by the claims and their equivalents.

What is claimed:

1. A Virtual World Presentation software system comprising:
A non-virtual world presentation;
A virtual world;
Attendee Avatars;
Means to display the non-virtual world presentation in the virtual world; and
Means to host the virtual world.

2. The Virtual World Presentation software system of claim 1 wherein the virtual world is created directly from a presentation creation software program through a plug-in based on the size, number of “slides” and other attributes of the non-virtual world presentation.

3. The Virtual World Presentation software system of claim 1 wherein a separate program imports the non-virtual world presentation and automatically creates a virtual world based on the size, number of “slides” and other attributes of the non-virtual world presentation.

4. The Virtual World Presentation software system of claim 1 wherein there is a plurality of virtual worlds for a virtual world presentation creator to choose from.

5. The Virtual World Presentation software system of claim 1 wherein the virtual world contains objects which a presentation creator may import text and/or graphics onto.

6. The Virtual World Presentation software system of claim 1 further comprising means to encourage an attendee avatar to certain positions and attitudes in the virtual world for the purpose of viewing the presentation.

7. The Virtual World Presentation software system of claim 1 further comprising a shared avatar which follows a path set by the presentation creator and is capable of being shared by multiple attendees at the same time.

8. The Virtual World Presentation software system of claim 1 further comprising a Presentation Avatar or Avatars.

9. The Virtual World Presentation software system of claim 8 wherein the Presentation Avatar is temporarily added to Attendee Avatar social lists.

10. The Virtual World Presentation software system of claim 1 further comprising means to play audio streams from attendees and/or presenters.

11. The Virtual World Presentation software system of claim 10 further comprising means to level the volume of the audio streams.

12. The Virtual World Presentation software system of claim 10 further comprising means for a presenter to control the volume of an individual audio stream and/or group of audio streams.

13. The Virtual World Presentation software system of claim 10 further comprising means to replay an audio stream.
